(19) United States
(12) Patent Application Publication
(10) Pub. No.: US 2008/0229536 A1
(43) Pub. Date: Sep. 25, 2008

(54) Motorcycle helmet visor wiper

(75) Inventor: Eric Yves Monpain, St-Leonard (CA)

Correspondence Address: ERIC MONPAIN, 8307 LEVRARD, St-Leonard, QC, H1R-2S7, CA

(73) Assignee: Mr. Eric Yves Monpain, St-Leonard, QC (CA)

(21) Appl. No.: 11/725,200

(22) Filed: Mar. 19, 2007

(51) Int. Cl. B08B 13/00

(52) U.S. Cl. 15/250.001

(57) ABSTRACT

A motorcycle or any helmet with a visor wiper. Simply an horizontal bar from one side of the helmet to the other side for most common full face helmets. It would be then manually moved up and down to wipe off water that as accumulated on the visor, anchor disks on each side hold the wiper assembly on the visor with a peel and stick 3m double sided tape.

This invention provides an improved way of getting accumulated water on the helmet visor off.

This is a safety feature that should be put on a helmet for visibility for the driver.

### CROSS REFERENCES TO RELATED APPLICATIONS

The differences between my invention and the invention of DE19740861A1 Inventor LEYSER FRANK are the anchor system to attach the wiper assembly to the visor and the blade that is removable on the face of the plastic band. The plastic band has also a slit in the middle, so the rubber that acts as a wiper can be replaced.

All other patents have no relation or don't come close to my invention.

### SUMMARY OF THE INVENTION

Considered a sport in some places, in some other places it is a means of transportation. Even though more and more safety features are installed on motorcycles and full face helmets, or any helmet with a visor. Some aspects of the helmet has been over looked, although a few ideas have come forward, the complications of all the apparatus found in my search have made it impossible for any manufacturing of any good wiper for motorcycle helmets. My invention is simple, will fit on 80% of all safety helmets that have a visor. It is a band (FIG. 2) made of flexible recycled plastic moulded to fit horizontally on the front of the top visor. Underneath there is a strip of foam (3) or three edges rubber strip (FIG. 3). It wipes the water and moves it to the bottom with a flick of the finger up and down. The plastic band as openings on each end. In those is inserted a extension spring and fixed there (4). In the other end of the spring (FIG. 4) the sleeves (FIG. 5) comes over the end of the band (FIG. 2). The sleeves (FIG. 5) on each end of the plastic band (FIG. 2) will act as a telescopic way to allow a play of two inches to provide space for the helmets inclination from the top of the visor to the bottom. To attach the sleeves (FIG. 5) holes at the end are provided to be set on a quick release button. The release button is part of the anchor that will be set on the visor itself, it consists of a disk (FIG. 6) that is glued with double side of tape. To stop the blade on top and bottom stoppers on the inside outer rim of the bottom disk (FIG. 6).

Once fasten properly this can make the blade move up and down. On the band (FIG. 2) itself, there is an opening called slit, in the middle that is there for replacing the wiper blade (FIG. 3).

### BRIEF DESCRIPTION OF THE SEVERAL VIEWS OF THE DRAWINGS

FIG. 1—Overview of the wiper installed on the safety helmet visor.

FIG. 2—Is the flexible plastic band.

FIG. 3—Is the strip of foam or three edges rubber strip.

FIG. 4—Is the extensions springs.

FIG. 5—Is the sleeves.

FIG. 6—The anchor disks.

### DETAILED DESCRIPTION OF THE INVENTION

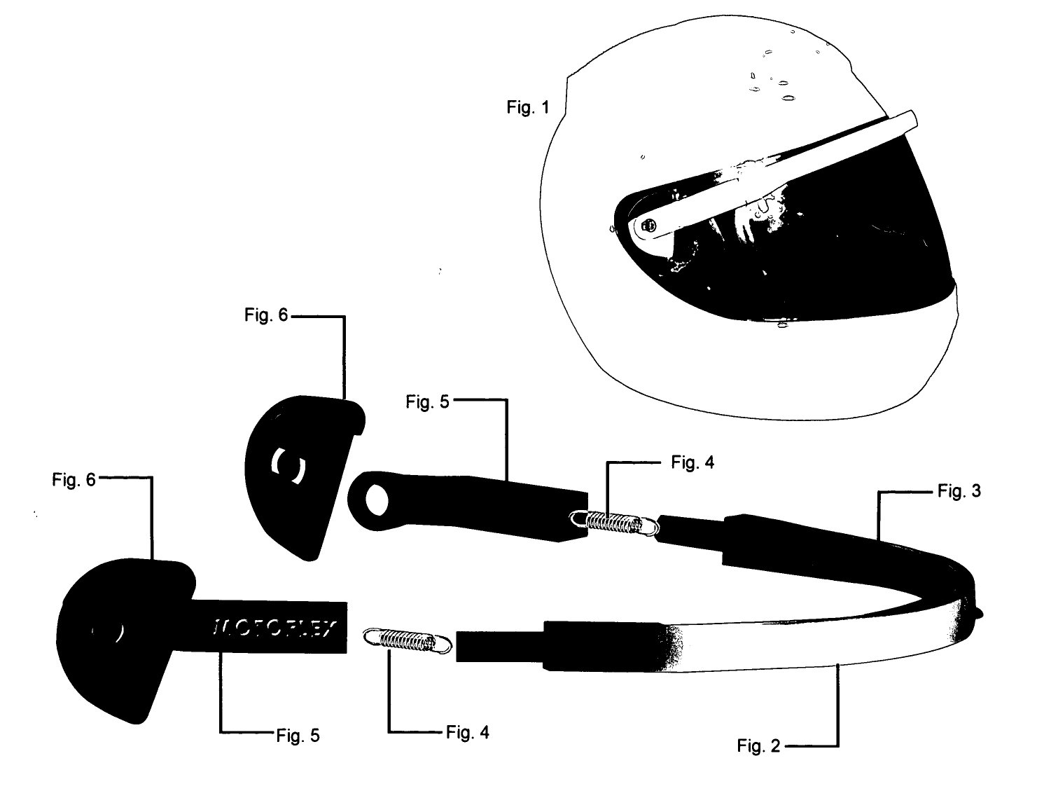

The blade is made of flexible plastic 28 cm. long self curving horizontally to the face of the visor. It is 2 cm. wide and 1 cm. thick (FIG. 2). On each end, an open space of 6 cm. deep, rectangular 1 cm. by 5 mm. From this opening, an extension spring (FIG. 4) attached will come out (FIG. 5) and attached in a plastic sleeve. The plastic sleeve (FIG. 5) opened at one end and a loop at the other (FIG. 5). Fixed underneath the plastic blade (FIG. 2) a piece of weather stripping foam or rubber 5 mm×5 mm thick and wide (FIG. 4). Bendable to the form of the helmets visor see FIG. 1. Also an opening in the middle a slit, so the wiper blade itself can be replaced. On the left side of the blade there is a tab 2 cm over the wideness of the blade from 5 cm. to 8 cm. This is used with your clutch hand to bring down the blade.

To hold the blade in place two plastic flat round plastic pieces (FIG. 6) with a quick release button. Glued with double sided 3m tape.

What is against the helmet is a round piece of plastic 3 mm thick 3 cm wide (FIG. 6). A stopper will be incorporated at the two o'clock position and the five o'clock position not letting the extension spring (FIG. 4) and its casing go beyond what is needed, letting the blade move down no more than 25 degrees clockwise. The extension spring (FIG. 4) is there to provide a play of 5 cm. to compensate for the angle in which the visor of a helmet is pronounced, different angles have been noticed on different brands of helmets so the adjustments will be done automatically by the stretch of the extension spring (FIG. 4). You will be able to remove the wiper assembly when not in need, but the two disks on each sides will remain. Can be easily carried in a pack sac.

Aesthetically the two small disks on each sides could be either transparent or any color. The thickness of the disks will not make it wind resistant.

1. What I claim as my invention is the anchor system that the wiper assembly attaches to and the same anchor system attaches to the visor.

2. What I claim as my invention is the plastic band with a slit in the middle for blade replacement.
